(19) United States
(12) Patent Application Publication
(10) Pub. No.: US 2024/0357481 A1
(43) Pub. Date: Oct. 24, 2024

(54) SYSTEM AND METHOD FOR SEGREGATING NETWORK SLICE TRAFFIC BASED ON DEVICE TYPES

(71) Applicant: Verizon Patent and Licensing Inc., Basking Ridge, NJ (US)

(72) Inventors: Suzann Hua, Beverly Hills, CA (US); Jerry Steben, Fort Worth, TX (US); Raymond WaiMan So, San Ramon, CA (US); Maqbool Chauhan, Keller, TX (US); Tony Ferreira, Fairfield, CT (US); Michael Kondratiuk, Hillsborough, NJ (US)

(21) Appl. No.: 18/304,767

(22) Filed: Apr. 21, 2023

(51) Int. Cl. H04W 48/18; H04W 36/00; H04W 76/10

(52) U.S. Cl. CPC H04W 48/18; H04W 36/0011; H04W 76/10

(57) ABSTRACT

A device in a network may be configured to: receive a request from a User Equipment (UE) device to establish a session with a network slice in the network; obtain a device type of the UE device; select, by using the device type, a Session Management Function (SMF), among a set of SMFs, which manages sessions for UE devices of the device type; and send a message to the selected SMF to create a session context. When the selected SMF receives the message, the selected SMF is configured to select a User Plane Function (UPF) based on the device type and cause the selected UPF to establish the session between the UE device and the network slice.

### BACKGROUND INFORMATION

Fifth Generation (5G) networks implement their core network functions based on the Service Based Architecture (SBA). According to the SBA, each network function fulfills the role of a service producer and the role of a service consumer. When a network function assumes the role of a service consumer, the network function may receive a service from a producer; and vice versa. Network Functions are mostly self-contained, independent, and reusable. Each network function may expose its functionality to other network functions through a Service Based Interface (SBI), using Hypertext Transfer Protocol (HTTP)/2.

### BRIEF DESCRIPTION OF THE DRAWINGS

FIG. 1 illustrates a simplified overview of segregating network slice traffic based on device types;

FIG. 2 illustrates an exemplary network environment in which systems and methods described herein may be implemented;

FIG. 3 depicts exemplary components of a core network, according to an implementation;

FIG. 4 illustrates a table of example features that may be implemented in network functions to support network slice traffic segregation based on device types, according to an implementation;

FIG. 5 is a flow diagram of an exemplary process that is associated with a system for segregating network slice traffic based on device types, according to an implementation;

FIGS. 6A and 6B illustrate exemplary messages that are exchanged by components of a system for segregating network slice traffic based on device types, according to an implementation; and

FIG. 7 depicts exemplary functional components of a network device according to an implementation.

### DETAILED DESCRIPTION

The following detailed description refers to the accompanying drawings. The same reference numbers in different drawings may identify the same or similar elements. As used herein, the term “device type” may refer to a unique category to which a User Equipment device (UE) may belong. A UE may belong to only one category in a set of predefined categories. Examples of a category includes a vehicle communication device, an Ultra Reliable Low Latency Communication (URLLC) device, an Internet-of-Things (IoT) device, a fast-moving communication device, etc.

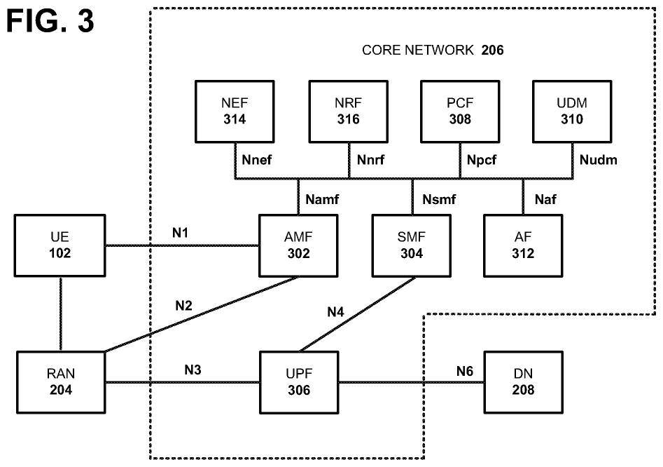

The systems and methods described herein relate to segregating network slice traffic based on device types and routing the segregated traffic to/from network slices through different paths. 5G networks permit traffic on a network slice to be distributed among network nodes, such as Session Management Functions (SMFs) (to be described in greater detail with reference to FIG. 3) and/or User Plane Functions (UPFs) (also to be described in greater detail with reference to FIG. 3), based on the location of a UE (e.g., a location identified by a Tracking Area Identifier (TAI)), a network slice identifier (ID), a data network name (DNN) of a network to which the UE is to or has established a session, and/or load conditions at the SMFs and/or the UPFs. By distributing the traffic on the network slice over different SMFs and UPFs, the network may be able to meet Qualify-of-Service (QOS) requirements in accordance with Service Level Agreements (SLAs) between the users and the network operator, avoid faulty conditions, and/or optimize its operation.

When network slice traffic originates or is destined for UEs, dedicating particular SMFs/UPFs to process network traffic to/from certain UE device types can improve network performance as well as facilitate its traffic analysis per device type. For example, a network operator may wish to dedicate a set of SMFs/UPFs for a network slice to handle traffic from fixed wireless access (FWA) devices and another set of SMFs/UPFs to handle traffic to/from IoT devices, as FWA devices and IoTs may be associated with different traffic patterns and QoS requirements. However, current implementations of 5G core network components do not support segregating network slice traffic based on UE device types.

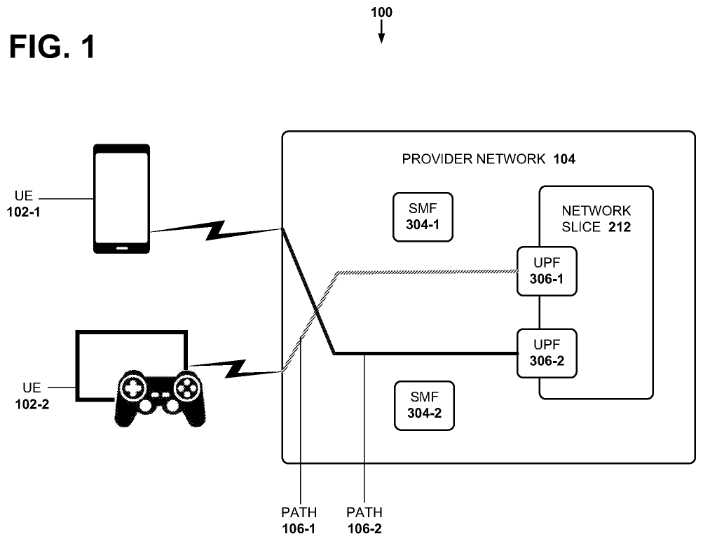

Systems and methods described herein relate to segregating network slice traffic based on device types. FIG. 1 illustrates a simplified overview of segregating network slice traffic based on device types. As shown, network environment 100 includes UEs 102-1 and 102-2 (collectively UEs 102 and generically UE 102) and a provider network 104 that includes a network slice 212. Although environment 100 may include many devices and/or network components, for clarity, they are not illustrated in FIG. 1.

Assume that UEs 102 are subscribed to provider network 104 and that, for each UE 102, the device type information (simply referred to as the device type) is stored along with a UE ID as part of a subscription information of the users of UEs 102 (e.g., in a subscription profile) at provider network 104. Also assume that UEs 102-1 and 102-2 belong to different device types. When UE 102-1 attaches to provider network 104, provider network 104 identifies the device type for UE 102-1 based on the subscription profile associated with UE 102-1 and by using the device type to look up which SMF in network 104 handles traffic for the device type. When UE 102-1 requests a connection to network slice 212, network 104 determines that SMF 304-1 manages the traffic for the device type of UE 102-1 and selects SMF 304-1 for managing the session for UE 102-1. After the selection, SMF 304-1 identifies a UPF 306-2 that handles traffic for the device type of UE 102-1 and network slice 212. Upon receipt of signals from SMF 304-1, UPF 306-1 and other network components set up a data path 306-1 from UE 102-1 to network slice 212.

Similarly, when UE 102-2 attaches to network 104, network 104 identifies the device type for UE 102-2 based on the subscription profile associated with UE 102-2 and, by using the device type, network 104 looks up which SMF in network 104 handles traffic for the device type. When UE 102-2 requests a connection to network slice 212, network 104 determines that SMF 304-2 handles the traffic for the device type of UE 102-2 and selects SMF 304-2 for managing the session for UE 102-2. After the selection, SMF 304-2 identifies a UPF 306-1 that handles traffic for the device type of UE 102-2 and network slice 212. Upon receipt of signals from SMF 304-2, UPF 306-1 and other network components set up a data path 306-2 from UE 102-2 to network slice 212.

In FIG. 1, although UE 102-1 and UE 102-2 connect to the same network slice 212, their traffic moves through different network paths to/from network slice 212. In other words, the traffic for or on network slice 212 is segregated based on the device types of UEs 102. Such segregation may be desirable, for example, if different paths (e.g., path 106-1 and 106-2) reflect different QoS when network slice 212 itself provides the same application service to both UEs or when the network slice 212 renders a particular QoS service.

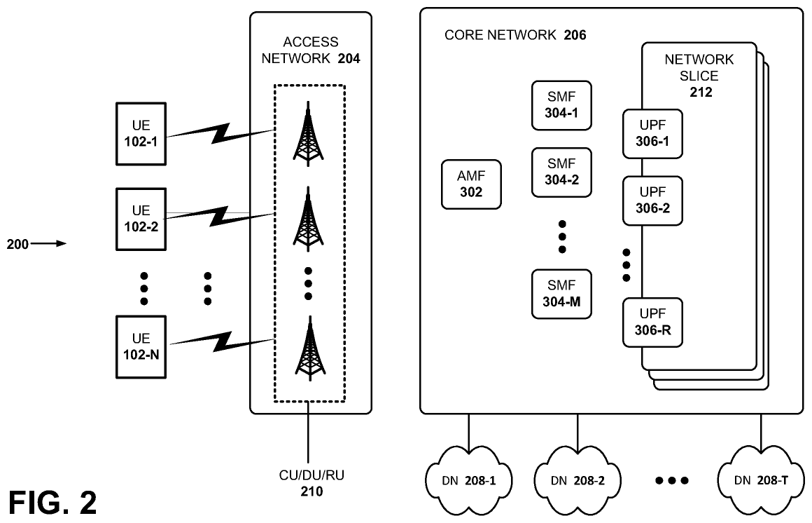

FIG. 2 illustrates an exemplary network environment 200 in which the system and methods may be implemented. As shown, environment 200 may include UEs 102-1 through 102-N (collectively referred to as UEs 102 and generically referred to as UE 102), access network 204, a core network 206, and data networks (DN) 208-1 through 208-T (collectively referred to as data networks 208 and generically as data network 208). Access network 204, core network 206, and data networks 208 may be part of provider network 104 (not shown in FIG. 2).

UEs 102 may include wireless communication devices capable of cellular communication, such as Fourth Generation (4G) (e.g., Long-Term Evolution (LTE)) communication and/or Fifth Generation (5G) New Radio (NR) communication. Examples of UE 102 include: a Fixed Wireless Access (FWA) device; a Customer Premises Equipment (CPE) device; a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

When the user of UE 102 subscribes with network 104 to receive communication services, network 104 may store information pertaining to UE 102, herein referred to as UE information, in the subscription profile for the user of UE 102. The UE information may include device type (information that identifies the type of device) and a UE identifier (ID). Examples of a UE ID include a Subscription Permanent Identifier (SUPI), a Subscription Concealed Identifier (SUCI), an International Mobile Subscriber Identity (IMSI), and a Mobile Station International Subscriber Directory Number (MSISDN).

Access network 204 may allow UE 102 to access core network 206. To do so, access network 204 may establish and maintain, with participation from UE 102, an over-the-air channel with the customer devices; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as CU/DU/RUs 210 (also referred to as access station 210) for establishing and maintaining over-the-air channel with UEs 102. In some implementations, access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Radio Access Network (eUTRAN).

Core network 206 may include one or more devices and network components for providing communication services to UEs 102. For example, core network 206 may permit UEs 102 to attach to network 104, establish sessions with devices in network 104, and/or receive services from network 104 (e.g., receive content, access the Internet, conduct video conferences with other UEs 102 attached to network 104. To deliver various services, core network 206 may interface with other networks, such as data networks 208.

As further shown, core networks 206 may each include one or more network slices 212. Depending on the implementation, network slices 212 may be implemented within other networks, such as access network 204 and/or data network 208. Access network 204, core networks 206, and data networks 208 may include multiple instances of network slice 212 (collectively referred to as network slices 212). Each network slice 212 may be instantiated as a result of “network slicing,” which involves a form of virtual network architecture that enables multiple logical networks to be implemented on top of a shared physical network infrastructure using software defined networking (SDN) and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular QoS class, a type of service, 5G QoS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI which identifies the network slice 212.

Depending on the implementation, core network 206 may include 5G core network components or 4G and/or LTE core network components. For example, core network 206 may include a Access and Mobility Management Function (AMF) 302, SMFs 304-1 through 304-M (collectively referred to as SMFs 304 or generically as SMF 304) and/or UPFs 306-1 through 306-R (collectively referred to as UPFs 306 and generically as UPF 306). Some of the core network components, including AMF 302, SMF 304, and UPF 306, are described in greater detail with reference to FIG. 3.

When UE 102 requests network 104 (e.g., via access network 204) for a connection with network slice 212, access network 204 hands off the request to AMF 302. Upon receipt of the request, AMF 304 derives the device type for UE 102. AMF 302 then uses the device type and the ID of the network slice 212 to select one of SMFs 304 to manage sessions between network slice 212 and UEs of the device type. The selected SMF 304 in turn selects, based on the device type, UPF 306 that is to set up the session between network slice 212 and the UE 102 and handle the network traffic, on network slice 212, to/from the UE 102.

For example, assume that in FIG. 2, the device type of UE 102-2 is a mobile phone. When UE 102 attaches to access station 210 and sends a request for a session with a network slice 212 to access station 210, access station 210 forwards the request to AMF 302 in core network 206. Assume that SMF 304-2 manages sessions between UEs of the mobile phone device type and the requested network slice 212; and that UPF 306-2 handles traffic for the network slice 212 for mobile phones. Accordingly, when AMF 302 receives the request for session from access station 210, AMF 302 selects and requests SMF 304-2 to manage the session between the UE 102 and network slice 212. In turn, SMF 304-2 selects UPF 306-2 to establish the session between UE 102 and network slice 212. In response, UPF 306-2 sets up the requested session and handles the traffic between the UE 102 and network slice 212. By having different SMFs 304 and UPFs 306 manage traffic for network slice 212 for different device types, network components 302-306 segregate network slice traffic based on different device types.

Data networks 208 may include one or more networks connected to core networks 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UEs 102 and may establish communication sessions with UEs 102 via core network 206.

For clarity, FIG. 2 does not show all components that may be included in network environment 200 (e.g., routers, bridges, wireless access point, additional networks, additional access stations 210, data centers, portals, etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts exemplary components of a core network 206 according to an implementation. As shown, core network 206 may include AMF 302, SMF 304, UPF 306, a Policy Control Function (PCF) 308, a Unified Data Management (UDM) 310, an Application Function (AF) 312, a Network Exposure Function (NEF) 314, and a Network Repository Function (NRF) 316. Each of components 302-316 may include functionalities for supporting segregation of network slice traffic based on device types. Because core components 302-316 are implemented in accordance with the (Service Based Architecture (SBA), components (or network functions) 302-316 communicate with one another over Service Based Interfaces (SBIs), with argument lists that may specify UE device types, where a called method for the network function includes the device type as one of its arguments/parameters the call method provides to the component/network function. In FIG. 3, although core network 206 is depicted as including network functions 302-316, in other implementations, core network 206 may include additional, fewer, and/or different 5G core network components than those illustrated in FIG. 3.

AMF 302 may perform registration management, connection management, reachability management, mobility management, lawful intercepts, Short Message Service (SMS) transport between UE 102 and a Short Message Service Function (SMSF), session management messages transport between UE 102 and SMF 304, access authentication and authorization, location services management, functionality to support non-Third Generation Partnership Program (3GPP) access networks, and/or other types of management processes. Other network functions may communicate with AMF 302 over the Namf interface. In addition, AMF 302 may interact with UE 102 and access network 204 (implemented as a RAN 204 in FIG. 3) over N1 and N2 interfaces, respectively.

To support network slice traffic segregation based on device types, AMF 302 may be implemented to store the device type for a UE 102 when UE 102 registers with AMF 302. That is, AMF 302 may store, for each UE 102 that successfully registers, one device type. When AMF 302 receives a request for session from UE 102 via access station 210, AMF 302 may then use the UE ID in the request to look up the device type for the UE 102. In a different implementation, AMF 302 may send a message to UDM 310 for information on UE 102, in effect, requesting UDM 310 to provide AMF 302 with the device type of UE 102. The message may include a UE ID, such as an IMSI, a SUPI, or another identifier that UDM 310 may use to locate the subscription profile and/or the device type.

When AMF 302 obtains the device type of UE 102, AMF 302 may use the device type and a slice ID (e.g., a slice instanced ID, an S-NSSAI, etc.) of the network slice 212 to which UE 102 is requesting to establish a session) to identify a particular SMF 304 for managing the session. If AMF 302 has a cached list of SMFs for managing traffic for different device types, AMF 302 may match the device types to the device type of the UE 102. If AMF 302 does not have a cached list of SMFs 304, AMF 302 may send a request to NRF 316 to identify a SMF 304 that manages sessions for the device type. When AMF 302 identifies the SMF 304, AMF 302 may request the identified SMF 304 to manage the session between the UE 102 and the network slice 212.

SMF 304 may perform session establishment, session modification, and/or session release, perform Internet Protocol (IP) address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate of charging data collection, terminate session management parts of Non-Access Stratum (NAS) messages, perform downlink data notification, manage roaming functionality, and/or perform other types of control plane processes for managing user plane data. Other network functions or components may communicate with SMF 304 over the Nsmf interface.

To support network slice traffic segregation based on UE device types, SMF 304 may be implemented to manage sessions between network slices 212 and UEs 102 of particular device types. For example, when SMF 304-2 receives a request to manage a session from AMF 302 for a particular device type, SMF 304-2 may select a UPF 306 that is to set up the session between network slice 212 and a UE 102 of a particular device type and handle the network traffic on network slice 212.

When selecting a UPF 306, if SMF 304 has a cached list of UPFs 306 with specified S-NSSAIs and/or device types, SMF 304 may attempt to match the S-NSSAIs and the device types to the S-NSSAI of the network slice 212 to which UE 102 wants to connect and the device type of the UE 102. If SMF 304 does not have a cached list of UPFs 306, SMF 304 may send a request to NRF 316 to identify a UPF 306 which can establish the session for UE device type and the network slice 212. When SMF 304 identifies the UPF 306, SMF 304 may request the identified UPF 306 to set up the session between the UE 102 and the network slice 212.

UPF 306 may maintain an anchor point for intra/inter-RAT mobility, maintain an external protocol data unit (PDU) point of interconnect to a particular data network (e.g., data network 208), perform packet routing and forwarding, perform the user plane part of policy rule enforcement, perform packet inspection, perform lawful intercept, perform traffic usage reporting, perform Quality of Service (QOS) handling in the user plane, perform uplink traffic verification, perform transport level packet marking, perform downlink packet buffering, forward an “end marker” to a RAN node (e.g., gNB), and/or perform other types of user plane processes. UPF 306 may interact with RAN 204, SMF 304, and data network (DN) 208 over N3, N4, and N6 interfaces. To support network slice traffic segregation based on UE device types, UPF 306 may be implemented to set up or modify sessions between network slices 212 and UEs 102 of particular device types.

PCF 308 may support policies to control network behavior, provide policy rules to control plane functions (e.g., to SMF 304), access subscription information relevant to policy decisions, perform policy decisions, and/or perform other types of processes associated with policy enforcement. Other network functions may communicate with PCF 308 over the Npcf interface. In some implementations, PCF 308 may be capable of forwarding policies to SMF 304 and/or UPF 306 to implement traffic segregation for network slices 212 based on device types.

UDM 310 may maintain subscription information for UEs 102, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store the data that it manages in a Unified Data Repository (UDR) (not shown). Network functions may interact with UDM 310 via the Nudm interface.

To support network slice traffic segregation based on UE device types, UDM 310 (and/or a UDR) may be configured to store, in subscription profiles for the users of UEs 102, a device type for each UE 102, along with one or more UE IDs (e.g., IMSI, SUPI, etc.). UDM 310 may provide the subscription profile, including device types and UE IDs to requesting network functions.

AF 312 may include applications (e.g., server applications) that render specific services to applications or components that run on UEs 102. Network functions may interact with AF 312 via the Naf interface. NEF 314 may expose network component capabilities and events internal to corresponding core network 206 and/or data networks 208 to devices and network functions external to core network 206. Network functions may interact with NEF 314 via the Nnef interface.

NRF 316 may support registration of network functions (NFs), discovery of network functions, and NF subscriptions. NRF 316 may maintain profiles of available NF instances and their supported services. An NF profile may include an NF instance identifier (ID), an NF type, a Public Land Mobile Network (PLMN) ID associated with the NF, network slice IDs associated with the NF (e.g., S-NSSAIs), capacity information for the NF, service authorization information for the NF, supported services associated with the NF, endpoint information for each supported service associated with the NF, and/or other types of NF information. When an NF is instantiated, the NF may register with NRF 316, sending its NF profile to NRF 316. Furthermore, when an NF needs to obtain information about another NF, the NF may query NRF 316 for the information. In response, NRF 316 may search its database of NF profiles and return results that match the query criteria.

To support network slice traffic segregation based on UE device types, NRF 316 may be implemented to store device type information for SMF 304, UPF 306, and/or any other network functions whose functionalities may be affected by UE device type. For example, when SMF 304 registers at NRF 316, SMF 304 may provide registration information that indicates one or more UE device types for UEs 102 whose sessions may be managed by SMF 304. NRF 316 may store the profile. Similarly, when UPF 304 registers at NRF 316, UPF 306 may provide registration information that indicates one or more device types for UEs 102 whose sessions UPF 306 may modify or establish between a UE 102 of the device type and network slice 212. When requested, NRF 316 may provide a SMF- or UPF-related information, including UE device types associated with the particular SMF/UPF instance.

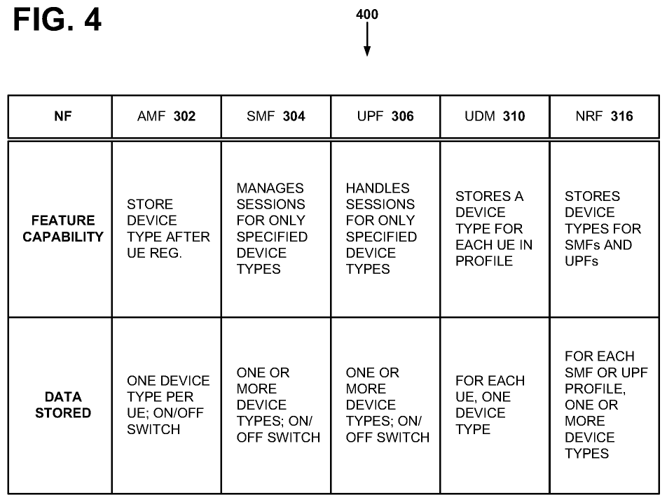

FIG. 4 illustrates a table 400 that show some features that NFs may implement to support network slice traffic segregation based on device types. That table 400 lists only some of the features discussed with reference to FIG. 3 for clarity and does not limit the invention. As shown, AMF 302, SMF 304, UPF 306, UDM 310, and NRF 316 may be configured to implement capabilities to, respectively: store a device type for each successful UE registration; manage sessions for only a specified set of UE device types; handle (e.g., create or modify) sessions for a specified set of UE device types; for each UE specified in a subscription profile, a device type; and store in each SMF profile or UPF profile, one or more UE device types. To support these features, AMF 302, SMF 304, UPF 306, UDM 310, and NRF 316 may store, respectively: a device type per UE 102; one or more device types; one or more device types; one device type for each UE; and one or more device types for each SMF/UPF profile.

In addition, to the above, each of AMF 302, SMF 304, and UPF 306 may include an ON/OFF switch (or a flag) that indicates whether AMF 302, SMF 304, and/or UPF 306 currently supports network slice traffic segregation based on device types. Another network function, such as PCF 308 may turn on or turn off the network slice segregation based on device types.

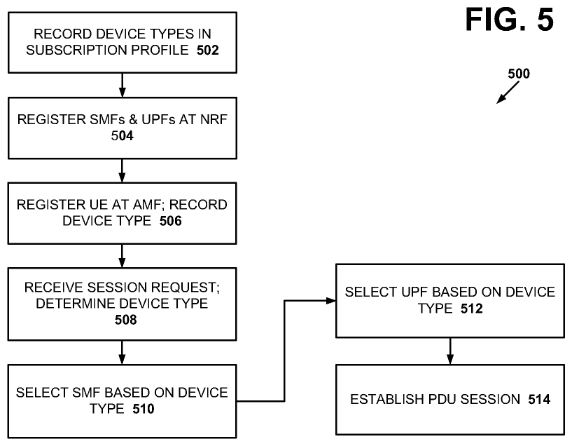

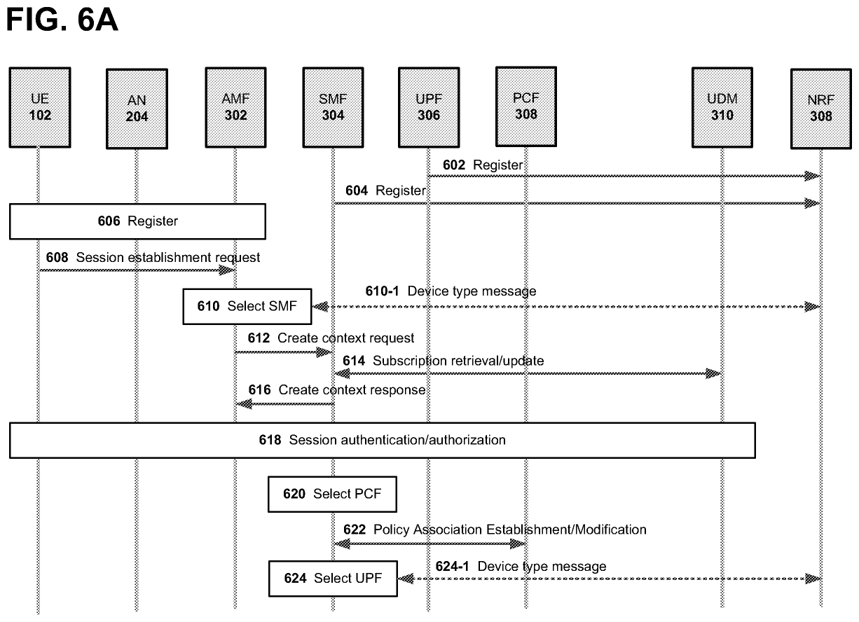

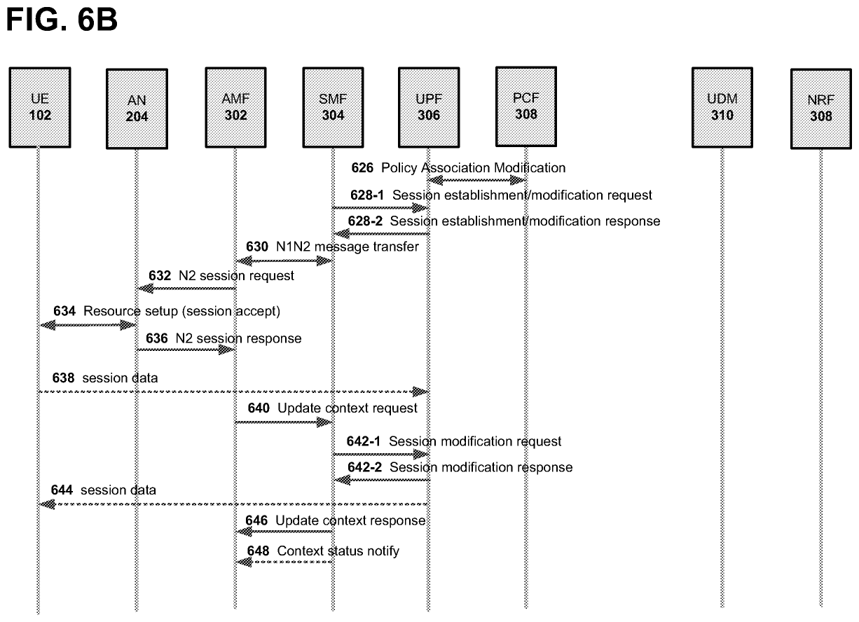

FIG. 5 is a flow diagram of an exemplary process 600 that is associated with a system for segregating network slice traffic based on device types, according to an implementation. During process 500, some of the components of the system may exchange messages. FIGS. 6A and 6B illustrate exemplary messages that are exchanged by components of the system for segregating network slice traffic based on device types. FIGS. 6A and 6B are described below in connection with process 500.

As shown, process 500 may include storing a device type for the user of UE 102 via UDM 310 (block 502). The actual storage may occur at a UDR. In addition, process 500 may include SMFs 304 and UPFs 306 registering at NRF 316 (block 504; arrows 602 and 604). NRF 316 may store profiles for SMFs 304 and UPFs 306, The profiles may specify device types for which the SMFs 304 and the UPFs 306 may manage and handle sessions.

Process 500 may further include UE 102 registering at AMF 302 over access network (AN) 204 (block 606). When UE 102 successfully registers at AMF 302 (block 506; block 606), AMF 302 stores the device type of the registered UE 102 along with a UE ID of the UE 102 (block 506). In some implementations, AMF 304 may not cache the device type of the UE 102. In such implementations, AMF 302 may query UDM 310 for device type information when necessary.

Process 500 may further include AMF 302 receiving a session establishment request from UE 102 over AN 204 (block 508; arrow 608). In response to the request, AMF 302 may determine the device type of the UE 102 (block 508). In some implementations, AMF 302 may use the UE ID provided in the request to look up the device type for the UE 102 in its cache of UE IDs and device type recorded during UE registrations. In other implementations, AMF 302 may send a request for information (e.g., subscription profile) to UDM 310, with the UE ID. In response, UDM 310 may forward the device type information for the UE 310 (arrow 610-1). Upon determining the device type, AMF 302 may then select an SMF 304 that may manage sessions for the device type (block 508; block 610). In some implementations, AMF 302 may not maintain a list of possible SMFs 304 from which AMF 302 can select the SMF 304 for managing the session. In such implementations, AMF 302 may send a request, with the UE ID, for the identity of one or more SMFs 304 that manage sessions for the device type. As discussed above, NRF 316 may include SMF profiles that indicate whether the SMF 304 may manage sessions for device types. NRF 316 may then provide the identity of the SMF 304 to AMF 302.

When AMF 302 selects the SMF 304 to handle the session for the UE 102 based on the device type, AMF 302 may send a request to create a context to the selected SMF 304 (arrow 612). The selected SMF 304 then obtains information needed to create the requested session context by sending a request to retrieve the subscription associated with the user of the UE 102 to UDM 310 (arrow 614). When UDM 310 provides the subscription information (arrow 614), SMF 304 may create a context for the session and forwards a create session context response message to AMF 302 (arrow 616). Thereafter, UE 102 may engage in session authentication over multiple network components and functions (block 618), such as AN 204, AMF 302, UDM 310, an Authentication Server Function (AUSF), etc. After a successful authentication, AMF 302 may select a PCF 308 (block 620) and interact with the selected PCF 308 to perform a policy association establishment/modification. During the process, SMF 304 may exchange messages with PCF 308 (arrow 622).

Process 500 may further include selecting a UPF 306 based on the device type (block 512; block 624). In some implementations, SMF 304 may not have at hand a list of possible UPFs 306 from which SMF 304 can select the UPF 306 for establishing or modifying the session for a device type. In such implementations, SMF 304 may send a request, with the UE ID, for the identity of one or more UPFs 306 that may create and/or modify sessions for the device type. As discussed above, NRF 316 may include UPF profiles that indicate whether a UPF 306 may create or modify sessions for device types. NRF 316 may then provide the identity of the UPF 306 to SMF 304.

Process 500 may further include establishing the session between UE 102 and the network slice 212 (block 514). Establishing the session may entail exchanges of multiple messages and performance of many sub-processes, some of which are shown in FIG. 6B. The messages may be exchanged via the SBI interfaces that include argument lists comprising the device type of the UE 102. As shown, establishing the session may include the selected UPF 306 exchanging messages for policy association modification (arrow 626); and SMF 304 sending a session establishment/modification request to UPF 306 (arrow 628-1) and receiving a session establishment/modification response from UPF 306 (arrow 628-2).

When SMF 304 receives the response from UPF 306, SMF 304 may initiate the remaining portion of the session establishment by exchanging N1: N2 transfer messages (arrow 630) with AMF 302. AMF 302 may then send an N2 session request to AN 204 (arrow 632). In response, AN 204 and UE 102 may set up resources (arrow 634) for the session, exchanging resource setup message and/or session accept message (arrow 636). This completes the establishment of the session and thus setting up the path for network traffic segregation based on UE device type.

With the session and the path for network slice traffic segregation set up, UE 102 may then send and/or receive session data to/from the network slice 212 through UPF 306 (arrow 638; arrow 644). After the uplink data is transmitted from UE 102 but before sending any downlink data, however, AMF 302 may request SMF 304 to change the session context (arrow 640). In response, SMF 304 may forward a session modification request (arrow 642-1) to UPF 306, which may then modify the session and reply with a session modification response (arrow 642-2). UPF 306 may then send downlink data to UE 102 over multiple components (arrow 644). With the session modified, SMF 304 may message AMF 302, providing an update context response (arrow 646). If there are additional updates, SMF 304 may send context change notifications to AMF 302 (arrow 648).

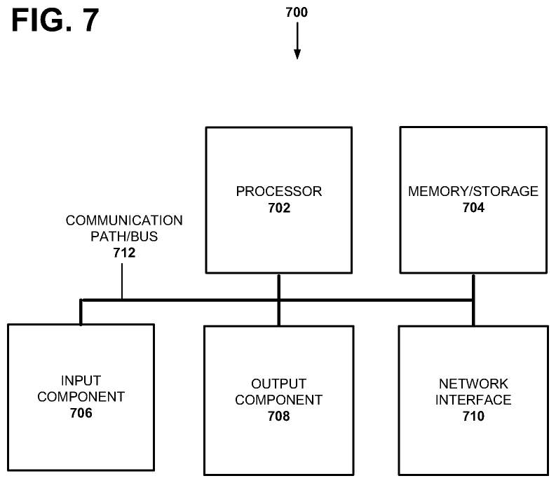

FIG. 7 depicts exemplary components of a network device 700. Network device 700 may correspond to or be included in any of the devices and/or components illustrated in FIGS. 1-3, 6A, and 6B (e.g., UE 102, access network 204, core network 206, data network 208, access station 210, and NFs 302-316). In some implementations, network devices 700 may be part of a hardware network layer on top of which other network layers and NFs may be implemented.

As shown, network device 700 may include a processor 702, memory/storage 704, input component 706, output component 708, network interface 710, and communication path 712. In different implementations, network device 700 may include additional, fewer, different, or different arrangement of components than the ones illustrated in FIG. 7. For example, network device 700 may include line cards, switch fabrics, modems, etc.

Processor 702 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.). Memory/storage 704 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700. Memory/storage 704 may include, for example, a Universal Serial Bus (USB) memory stick, a dongle, a hard disk, off-line storage, a Blu-Ray® disk (BD), etc. Memory/storage 704 may also include devices that can function both as a RAM-like component or persistent storage, such as Intel® Optane memories.

Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input/output components 706 and 708 may include a display screen, a keyboard, a mouse, a speaker, a microphone, a camera, a DVD reader, USB lines, and/or other types of components for obtaining, from physical events or phenomena, to and/or from signals that pertain to network device 700.

Network interface 710 may include a transceiver (e.g., a transmitter and a receiver) for network device 710 to communicate with other devices and/or systems. For example, via network interface 710, network device 700 may communicate over a network, such as the Internet, an intranet, cellular, a terrestrial wireless network (e.g., a WLAN, WIFI, WIMAX, etc.), a satellite-based network, optical network, etc. Network interface 710 may include a modem, an Ethernet interface to a LAN, and/or an interface/connection for connecting network device 700 to other devices (e.g., a Bluetooth interface).

Communication path or bus 712 may provide an interface through which components of network device 700 can communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory/storage 704, when executed by processor 702, may cause processor 702 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 5, 6A, and 6B, the order of the actions, messages, and signals may be modified in other implementations. In addition, non-dependent actions, messages, and signals may represent actions, messages, and signals that can be performed, sent, and/or received in parallel and in different orders. Furthermore, each actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising a device, in a network, configured to:
receive a request from a User Equipment (UE) device to establish a session with a network slice in the network;
obtain a device type of the UE device;
select, based on the device type, a Session Management Function (SMF), among a set of SMFs, which manages sessions for UE devices of the device type; and
send a message to the selected SMF to create a session context,
wherein when the selected SMF receives the message, the selected SMF is configured to select a User Plane Function (UPF) based on the device type and cause the selected UPF to establish the session between the UE device and the network slice.

2. The system of claim 1, wherein when the device obtains the device type of the UE device, the device is configured to:
use a UE identifier (ID) provided in the request to look up the device type from a list of UE IDs and device types.

3. The system of claim 2, wherein the device is further configured to:
store the device type of the UE device and the UE ID when the UE device registers with the device.

4. The system of claim 1, wherein when the device obtains the device type of the UE device, the device is configured to:
send a message to a Unified Data Management (UDM) to retrieve the device type from a subscription profile of a user of the UE device.

5. The system of claim 1, wherein when the device selects the SMF, the device is configured to:
send a message that includes the device type to a Network Repository Function (NRF) to obtain a reply that identifies the selected SMF.

6. The system of claim 1, wherein when the selected SMF selects the UPF, the selected SMF is configured to:
send a message that includes the device type to a Network Repository Function (NRF) to obtain a reply that identifies the selected UPF.

7. The system of claim 1, further comprising a Network Repository Function (NRF) that includes:
a first profile for the selected SMF, wherein the first profile specifies device types of UE devices whose sessions that the selected SMF manages; and
a second profile for the selected UPF, wherein the second profile specifies device types of UE devices whose sessions that the selected UPF establishes.

8. The system of claim 1, wherein each SMF in the set of SMFs includes a flag that specifies whether the SMF uses the device type of the UE device to select the UPF.

9. The system of claim 1, wherein the network slice receives network traffic via multiple UPFs, and the multiple UPFs include the selected UPF.

10. The system of claim 1, wherein the selected SMF is configured to receive a Service Based Interface (SBI) call whose argument list includes the device type as one of input parameters.

11. A method comprising:
receiving a request from a User Equipment (UE) device to establish a session with a network slice in a network;
obtaining a device type of the UE device;
selecting, based on the device type, a Session Management Function (SMF), among a set of SMFs, which manages sessions for UE devices of the device type; and
sending a message to the selected SMF to create a session context,
wherein when the selected SMF receives the message, the selected SMF is configured to select a User Plane Function (UPF) based on the device type and cause the selected UPF to establish the session between the UE device and the network slice.

12. The method of claim 11, wherein obtaining the device type of the UE device includes:
using a UE identifier (ID) provided in the request to look up the device type from a list of UE IDs and device types.

13. The method of claim 12, further comprising:
storing the device type of the UE device and the UE ID when the UE device registers.

14. The method of claim 1, wherein obtaining the device type of the UE device includes:
sending a message to a Unified Data Management (UDM) to retrieve the device type from a subscription profile of a user of the UE device.

15. The method of claim 11, wherein selecting the SMF includes:
sending a message that includes the device type to a Network Repository Function (NRF) to obtain a reply that identifies the selected SMF.

16. The method of claim 11, wherein when the selected SMF selects the UPF, the selected SMF is configured to:
send a message that includes the device type to a Network Repository Function (NRF) to obtain a reply that identifies the selected UPF.

17. The method of claim 11, further comprising:
storing, by a Network Repository Function (NRF), a first profile for the selected SMF, wherein the first profile specifies device types of UE devices whose sessions that the selected SMF manages; and
storing, by the NRF, a second profile for the selected UPF, wherein the second profile specifies device types of UE devices whose sessions that the selected UPF establishes.

18. The method of claim 11, wherein each SMF in the set of SMFs includes a flag that specifies whether the SMF uses the device type of the UE device to select the UPF.

19. The method of claim 11, wherein the network slice receives network traffic via multiple UPFs, and the multiple UPFs include the selected UPF.

20. A non-transitory computer-readable medium comprising processor-executable instructions, which when executed by one or more processors of a device in a network, cause the one or more processors to:
receive a request from a User Equipment (UE) device to establish a session with a network slice in the network;
obtain a device type of the UE device;
select, based on the device type, a Session Management Function (SMF), among a set of SMFs, which manages sessions for UE devices of the device type; and
send a message to the selected SMF to create a session context,
wherein when the selected SMF receives the message, the selected SMF is configured to select a User Plane Function (UPF) based on the device type and cause the selected UPF to establish the session between the UE device and the network slice.
